(19) United States
(12) Patent Application Publication
(10) Pub. No.: US 2013/0333021 A1
(43) Pub. Date: Dec. 12, 2013

(54) PREVENTING MALICIOUS SOFTWARE FROM UTILIZING ACCESS RIGHTS

(71) Applicants: Christopher L. SELLERS, Missoula, MT (US); Benjamin Kyrk ULLMAN, Chandler, AZ (US)

(72) Inventors: Christopher L. SELLERS, Missoula, MT (US); Benjamin Kyrk ULLMAN, Chandler, AZ (US)

(73) Assignee: FORTY1 TECHNOLOGIES INC., Dallas, TX (US)

(21) Appl. No.: 13/492,747

(22) Filed: Jun. 8, 2012

(51) Int. Cl. G06F 21/22

(52) U.S. Cl. 726/17

(57) ABSTRACT

In a first embodiment of the present invention, a method for enabling a device to block malicious software is provided, comprising: creating a super-user account as a new account for an operating system running on a device; and altering security rights of the operating system so that all accounts other than the super-user account of the operating system running on the device have only read access to key sections of the operating system.

### BACKGROUND OF THE INVENTION

Malicious computer software (e.g., Trojan horses, Worms, Spyware, Viruses, etc.) are a known and constant threat to businesses and individuals. There are various methods of infection, propagation, and concealment of such malware. Indeed, for every solution that anti-virus manufacturers come up with, malware creators find two workarounds.

Various antivirus programs exist in the market today. The goal of such software is to prevent infection and/or remove the infection once it is detected. These programs run by utilizing a database of known malware signatures. The antivirus manufacturer periodically updates the database to identify new malware. A user installs the antivirus software on his or her computer, and then the program constantly runs in the background of the computer system. This has a number of drawbacks. First of all, because the antivirus program is continuously running in the background, it eats up valuable processing time and other resources, slowing down the system as a whole. Second of all, it requires updates in order to be effective, updates which take up user time and/or bandwidth to download. Third of all, given the volume of malware in existence, the signature databases have now grown to be very large, which takes up space on the computer system as well as means that even more processing power is needed to scan through the entire database of signatures. Such problems are only going to get worse, as the number of malicious programs is always increasing, never decreasing.

What is needed is a solution that does not require background operation, constant updates, or an ever-increasing number of signatures in a database.

### SUMMARY OF THE INVENTION

In a first embodiment of the present invention, a method for enabling a device to block malicious software is provided, comprising: creating a super-user account as a new account for an operating system running on a device; and altering security rights of the operating system so that all accounts other than the super-user account of the operating system running on the device have only read access to key sections of the operating system.

In a second embodiment of the present invention, a method for enabling blocking malicious software is provided, comprising: receiving a command to open a file; prompting the user as to how to run the command, wherein the prompting includes asking the user to select “high-risk” or “low-risk”; and when the user selects “high-risk,” running the command in a guest mode, where the command is not allowed to access any part of the operating system.

In a third embodiment of the present invention, a computer system is provided comprising: a processor; an operating system, wherein the operating system contains key sections and non-key sections; a user account module, wherein the user account module is configured to: create a super-user account as a new account for the operating system; and alter security rights of the operating system so that all accounts other than the super-user account of the operating system running on the device have only read access to the key sections of the operating system.

In a fourth embodiment of the present invention, a program storage device readable by a machine tangibly embodying a program of instructions executable by the machine to perform a method for enabling a device to block malicious software is provided, the method comprising: creating a super-user account as a new account for an operating system running on a device; and altering security rights of the operating system so that all accounts other than the super-user account of the operating system running on the device have only read access to key sections of the operating system.

In a fifth embodiment of the present invention, a program storage device readable by a machine tangibly embodying a program of instructions executable by the machine to perform a method for enabling blocking malicious software is provided, the method comprising: receiving a command to open a file; prompting the user as to how to run the command, wherein the prompting includes asking the user to select “high-risk” or “low-risk”; and when the user selects “high-risk,” running the command in a guest mode, where the command is not allowed to access any part of the operating system.

### BRIEF DESCRIPTION OF THE DRAWINGS

FIG. 1 is a flow diagram illustrating a method for blocking malicious software in accordance with an embodiment of the present invention.

FIG. 2 is a flow diagram illustrating another method for blocking malicious software in accordance with an embodiment of the present invention.

FIG. 3 is a flow diagram illustrating a method for blocking malicious software in accordance with an alternative embodiment of the present invention.

FIGS. 4-12 are screen captures illustrating a case study of the effects and effectiveness of a malware-blocking system in accordance with an embodiment of the present invention.

### DETAILED DESCRIPTION

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

In an embodiment of the present invention, malicious programs are prevented from accessing files or services on a computer system by blocking access rights. Doing so eliminates the need to maintain, utilize, and update signature databases, freeing the present invention from the drawbacks of prior art solutions.

Most operating systems allow for user accounts. A user account defines the actions a user can perform in the operating system. On a stand-alone computer or a computer that is a member of a workgroup, a user account establishes the privileges assigned to each user. On a computer that is part of a network domain, a user must be a member of at least one group. The permissions and rights granted to a group are assigned to its members. Whatever type of computer system the user account is set up for, the rights and permissions may include security rights, which involve the right to access certain files, processes, and services of the computer system.

The present invention utilizes this user account mechanism to prevent malicious software from gaining control over an operating system Specifically, the user account mechanism is modified to make it difficult if not impossible for malicious software to access certain commands without explicit permission from a user of the computer. This enables the system to effectively block malicious software without requiring the use of processor-dependent anti-malware software.

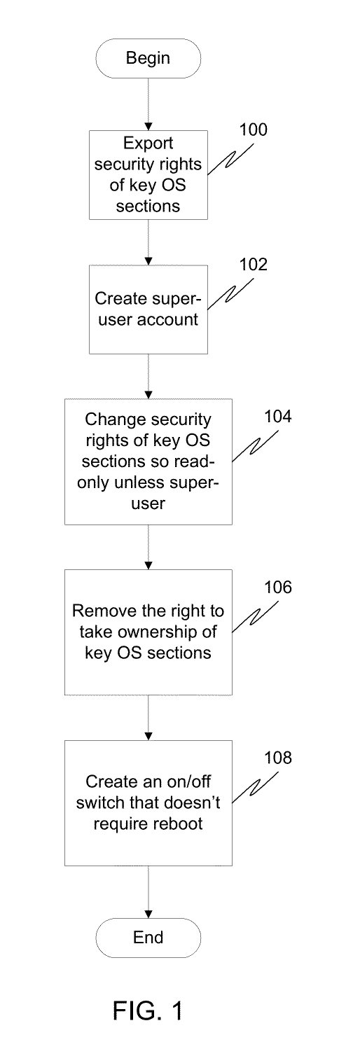

FIG. 1 is a flow diagram illustrating a method for blocking malicious software in accordance with an embodiment of the present invention. The method depicted is performed at installation time. In other words, the steps involved are all performed in order to set the system up to a state where blocking of malicious software occurs. In one embodiment, these steps are all undertaken at a single computer, such as a desktop or laptop computer. In other embodiments, some of the steps may be performed remotely, such as by an administrator at a server with other steps being performed on local client computers.

At 100, the security rights defined for key sections of the operating system can be exported. A key section may be defined as any portion of the operating system that has the potential to be exploited by malware. Examples include sections that allow programs to run automatically, sections that work as “add-ons” for other programs (such as Internet Explorer and a toolbar, as well as file management apps that add menus to the right click context), the entire boot sector, Layered Service Providers (LSPs) that add network functionality to the TCP/IP stack, system drivers folders, and nearly all folders in the main windows folder and subfolders. More specific examples include the following:

### HKEY_LOCAL_MACHINE\SOFTWARE\Microsoft\Windows

### NT\CurrentVersion\Winlogon\AppSetup

HKEY_LOCAL_MACHINE\SoftwareTolicies\Microsoft\Windows\System\Scripts\S tartup

### HKEY_LOCAL_MACHINE\Software\Microsoft\Windows\CurrentVersionWolicies\System\Shell

### HKEY_LOCAL_MACHINE\Software\Classes\.exe

### HKEY_LOCAL_MACHINE\SOFTWARE\Microsoft\Windows\CurrentVersion\Run

### HKEY_Current_User\Software\Microsoft\Windows\CurrentVersion\Run

HKEY_CLASSES_ROOT\exefile\shethopen\command

### C:\Windows\Explorer.exe

### HKLM\SOFTWARE\Microsoft\Windows

### NT\CurrentVersion\Winlogon\SpecialAccounts\UserList

Exporting involves copying the security rights to a different location than they are normally stored by the operating system. This may mean copying the security rights to some other area of memory accessible by the computer system, such as another area of a hard drive. Alternatively, the security rights can be copied to a remote storage location, such as to a server. In another embodiment of the present invention, the security rights can be exported to a cloud. Wherever the security rights are ultimately stored, this copying is performed so that the actions involved in installing the present invention can be reversed if necessary.

At 102, a new account is created on the operating system. This new account may be called a “super-user.” The “super-user” account will wind up having privileges to access the key sections of the operating system. The super-user account may be created either on the local computer, or on a domain controller if applicable. On Windows Server Systems, a domain controller is a server that responds to security authentication requests (logging in, checking permissions, etc.) within the Windows Server domain. A domain is a concept introduced in Windows NT whereby a user may be granted access to a number of computer resources with the use of a single username and password combination.

At 104, the security rights of the identified key operating system sections are changed to allow only the super-user to make changes to them, and forcing all other user accounts (including a local “system” account) to only allow “read” access. The system account or “NT Authority\SYSTEM” is a powerful built in Windows account that has unrestricted access to all local system resources.

At 106, the “take ownership” right of members of the administrators' group can be removed from the key operating system sections. This helps to prevent a manual override of the present invention that would otherwise be possible if a user could take ownership of this right. Specifically, normally a user could effectively write themselves to the permissions list regardless of how the permissions were set. This applies to both files and registry entries. Performing this would give the user full control over the folder/registry entry in question. As such, it may be necessary to block this capability.

At 108, restoration of the original access rights to the key operating system sections is allowed. What this means is a functionality is provided where a user who wishes to revert back to the original operating system access rights can do without requiring a reboot. This process utilizes the exported security rights of the key operating system sections of step 100. The system can simply overwrite the current security rights of those key operating sections (which have been at least modified by step 104) with the exported security rights of the key operating system sections. As such, the security rights are made as if the invention was never installed or initiated. In one embodiment of the present invention, the right to take ownership of key operating system sections, which was removed at 106, is reinstated.

In one embodiment, the restoration of the original access rights to the key operating system sections can be performed without requiring a reboot, by virtue of the fact that, as stated above, the exported access rights can simply overwrite the current access rights.

It should be noted that in one embodiment a virtual “on/off” switch may be displayed to the user to implement this functionality, in reality any number of different implementations may be used for such a switch, including various graphical icons, menu items, text commands, etc.

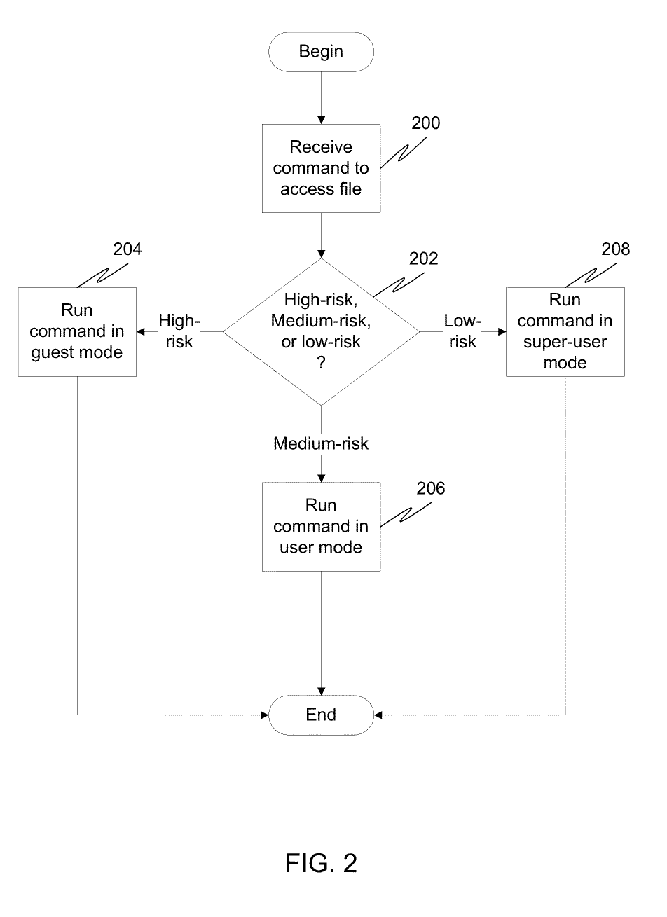

FIG. 2 is a flow diagram illustrating another method for blocking malicious software in accordance with an embodiment of the present invention. The method depicted is performed at run time. In other words, the steps involved are all performed when a user is running the operating system in a manner that he wished to block malicious programs.

At 200, a command to open a file is received. At 202, the user is then prompted to inquire how to run the command, i.e. what level of risk is assumed for this command. In one example, the user can select between “high-risk”, “medium-risk”, and “low-risk”. A “low-risk” command is one that the user has a high confidence is very safe. Examples include commands from programs downloaded from trusted sources, such as the operating system manufacturer. A “high-risk” command is one that the user has significant doubts as to whether it is safe. Examples include commands from files attached to unsolicited emails. A “medium-risk” command lies somewhere between “high-risk” and “low-risk”.

The effect of the user's selection is depicted as 204, 206, and 208. If the user selected “high-risk”, then the command is run in guest mode at 204. In guest mode, the command is essentially not allowed to access any part of the operating system, not even to do very basic things like save files to a desktop or server. If the user selected “medium-risk”, then at 206 the command is run in user mode, which allows the command to perform generally non-threatening tasks, such as saving files to the desktop or server. If the user selected “low-risk”, then the command is run in super-user mode at 208, where the command is allowed full access rights. As such, the user is generally cautioned to be very careful in allowing the command to run in “low-risk” mode.

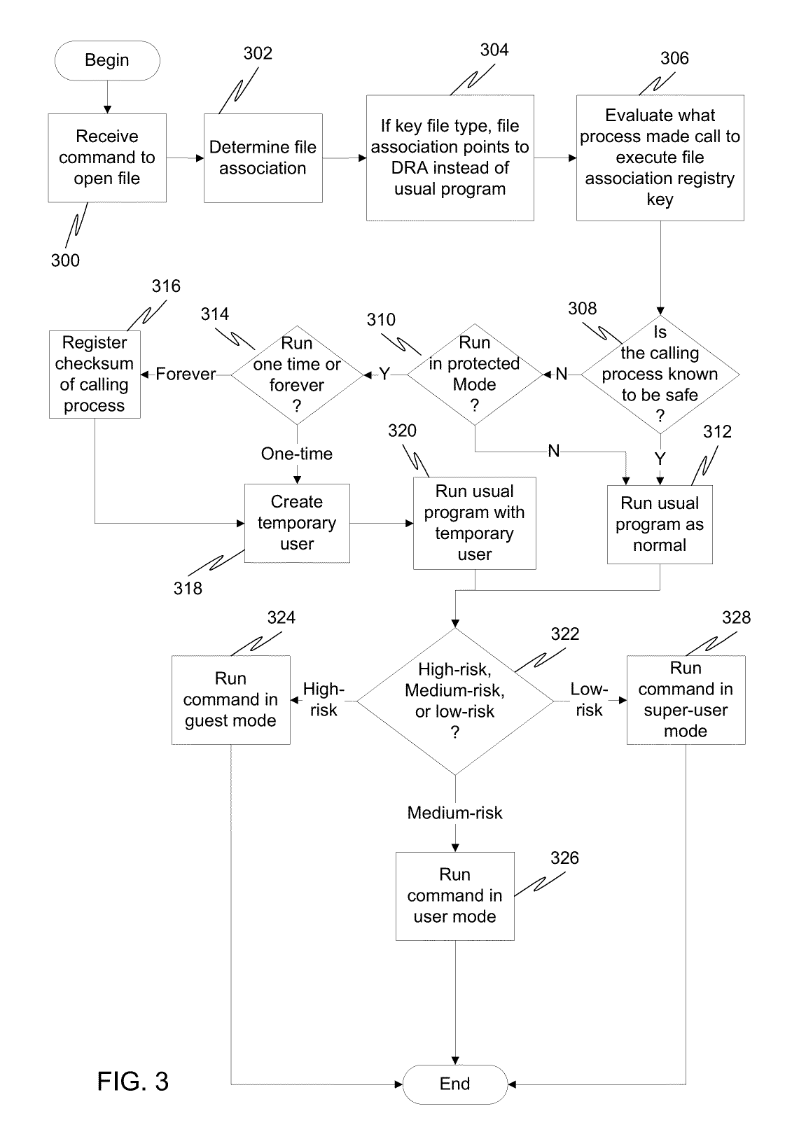

Notably, the run-time method of FIG. 2 may actually be run in the context of a larger method for blocking malicious software involving dynamic rights assignment (DRA). FIG. 3 is a flow diagram illustrating a method for blocking malicious software in accordance with this alternative embodiment of the present invention. At 300, a command to open a file is received. At 302, the file association of the file is determined. At 304, if the file association is a key file type, then the file association, when followed, will point to a dynamic rights assignment module rather than the usual program. This is because during initialization, the system will update key file type file associations to point to the dynamic rights assignment module. At 306, the system evaluates what process made the call to execute the file association registry key. At 308, it is determined if the calling process is known to be safe. If not, then at 310 it is determined if the system should run in protected mode. If not, or if at 308 it is determined that the calling process is known to be safe, then at 312 the usual program is run as normal. In other words, if the calling process is known to be safe, DRA can largely be ignored. If at 310 it was determined that the command was going to be run in protected mode, then at 314 it is determined if the command is going to be run one time or forever using these security settings. If forever, then at 316 the checksum of the calling process can be registered. After that, or if at 314 it is determined to run using only a single-time using these security settings, then at 318 a temporary user is created. At 320, the usual program is then run using the temporary user.

At 322, the user is then prompted to inquire how to run the command, i.e. what level of risk is assumed for this command. In one example, the user can select between “high-risk”, “medium-risk”, and “low-risk”. The effect of the user's selection is depicted as 324, 326, and 328. If the user selected “high-risk”, then the command is run in guest mode at 324. In guest mode, the command is essentially not allowed to access any part of the operating system, not even to do very basic things like save files to a desktop or server. If the user selected “medium-risk”, then at 326 the command is run in user mode, which allows the command to perform generally non-threatening tasks, such as saving files to the desktop or server. If the user selected “low-risk”, then the command is run in super-user mode at 328, where the command is allowed full access rights. As such, the user is generally cautioned to be very careful in allowing the command to run in “low-risk” mode.

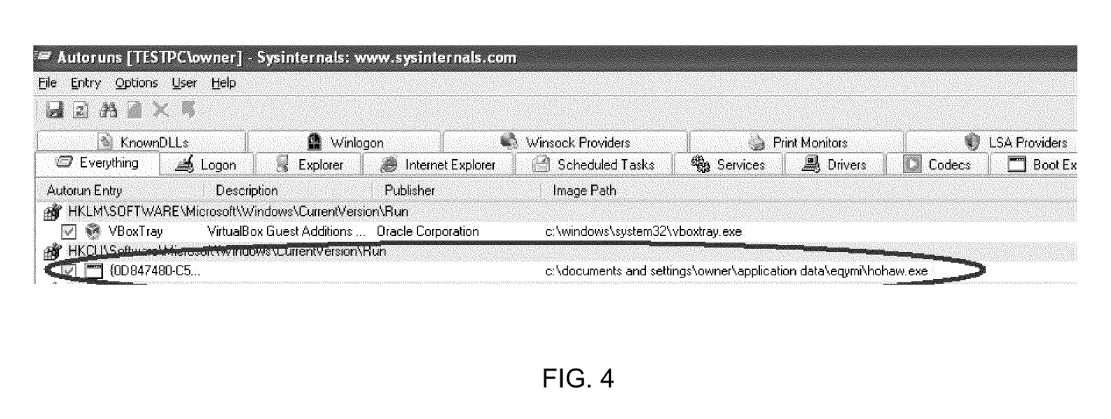

FIGS. 4-12 are screen captures illustrating a case study of the effects and effectiveness of a malware-blocking system in accordance with an embodiment of the present invention. In this case study, it is assumed a virus named “Zeus” exists and that Zeus' primary objective is stealing credit card, banking, and online account information.

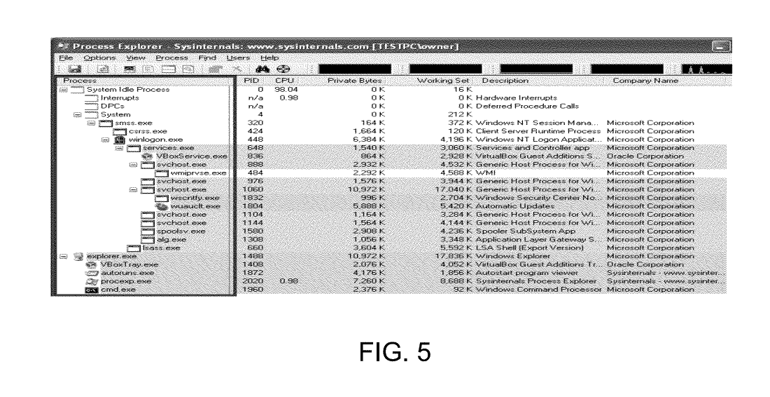

With no protection (anti-virus or other malware blocker, such as an implementation of the present invention), the machine is instantly infected. The machine's registry is compromised, and all user accounts are infected as well. Zeus is in fact configured to run each time the machine starts, as can be seen in FIG. 4, showing the infected executable set to run automatically on each boot. Additionally, as seen in FIG. 5, there is no indication that the infection has taken place, with the exception of a small slow down in running Internet Explorer when the virus was installing. No trace of the virus can be found by viewing running programs.

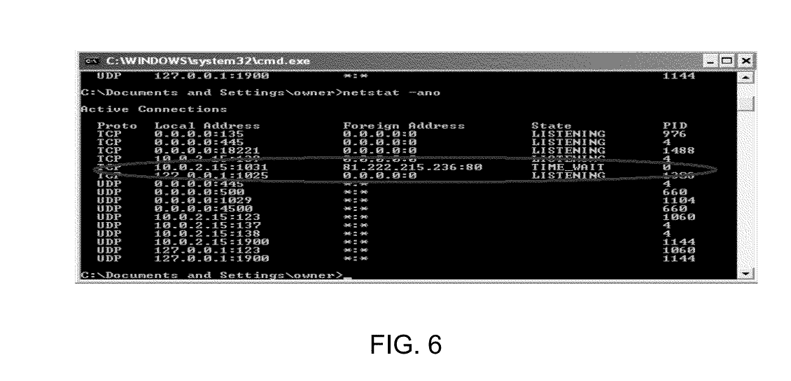

Furthermore, as can be seen in FIG. 6, the virus attempts to covertly connect back to a “botmaster”, or person controlling the infected machines. This is done silently, in the background, using a system process (PID 0) to prevent detection.

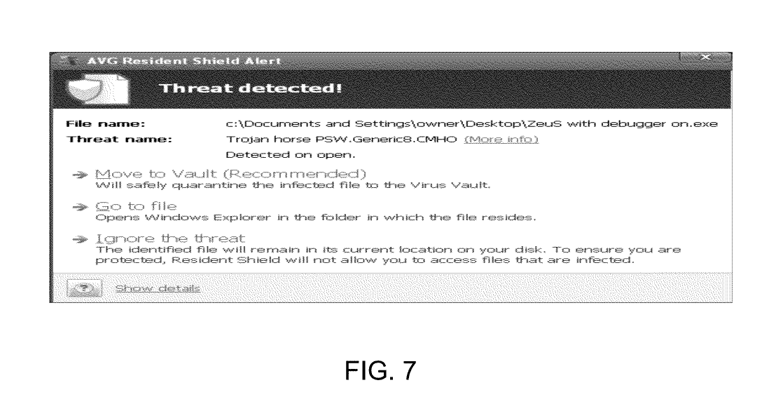

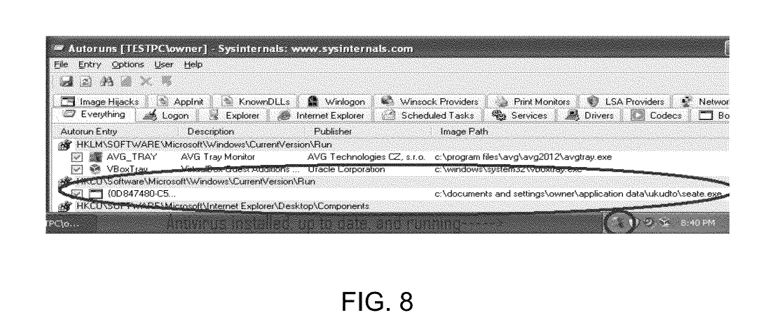

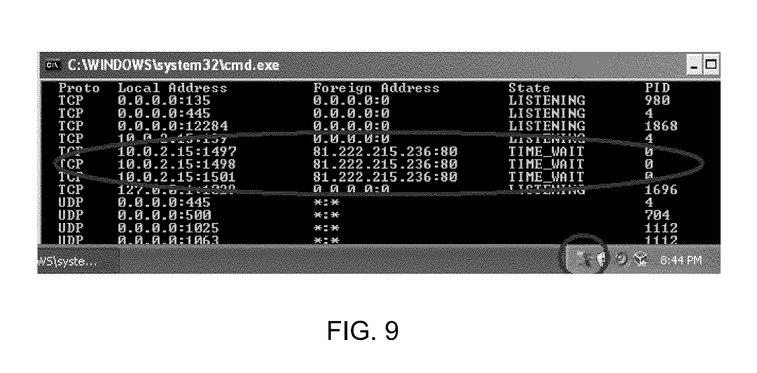

FIGS. 7-9 depict screen captures of how Zeus is handled by a traditional anti-virus software. In FIG. 7, the virus is detected on manual execution of the anti-virus software. While detected when running the anti-virus program itself, or when running the virus executable directly from a desktop via a double click, the virus is in fact not detected when installed via “drive-by-download” and the machine becomes infected just as if there was no antivirus program at all. In FIG. 8, the virus is set to run automatically. In FIG. 9, the virus still attempts to connect back to its botmaster, even with the Antivirus program working.

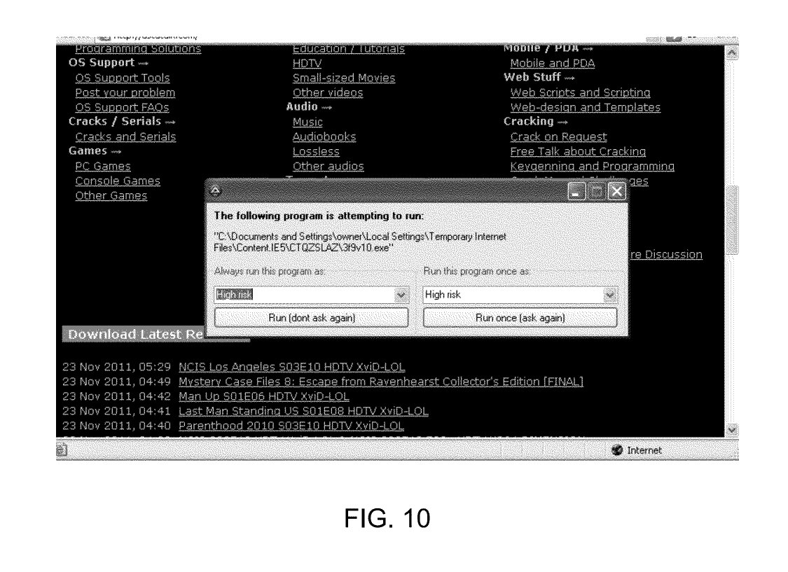

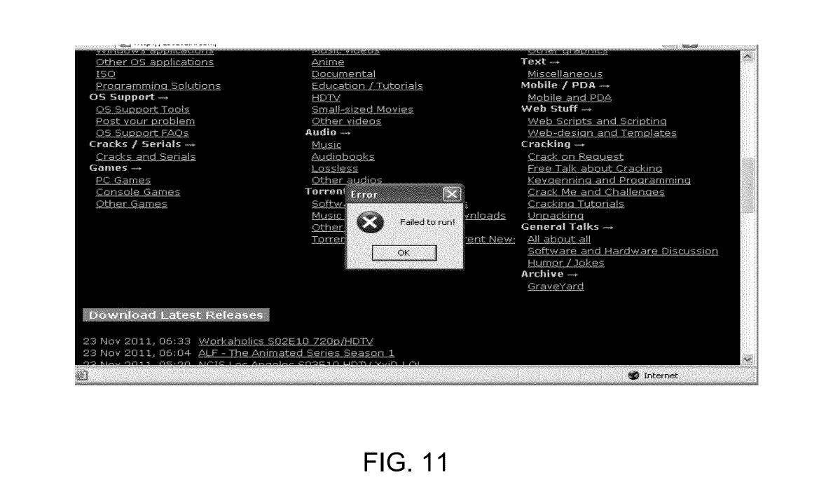

FIGS. 10-14 depict screen captures of how Zeus is handled by an embodiment of the present invention. In FIG. 10, the drive-by-download of the virus is automatically detected and classified as being high-risk. The user is presented with options to classify the process as such, and whether to run the process forever or just once using the selected risk settings. Since the virus is classified as high-risk, it becomes impossible for the virus to execute. Thus, in FIG. 11, the virus crashes upon execution in protected mode.

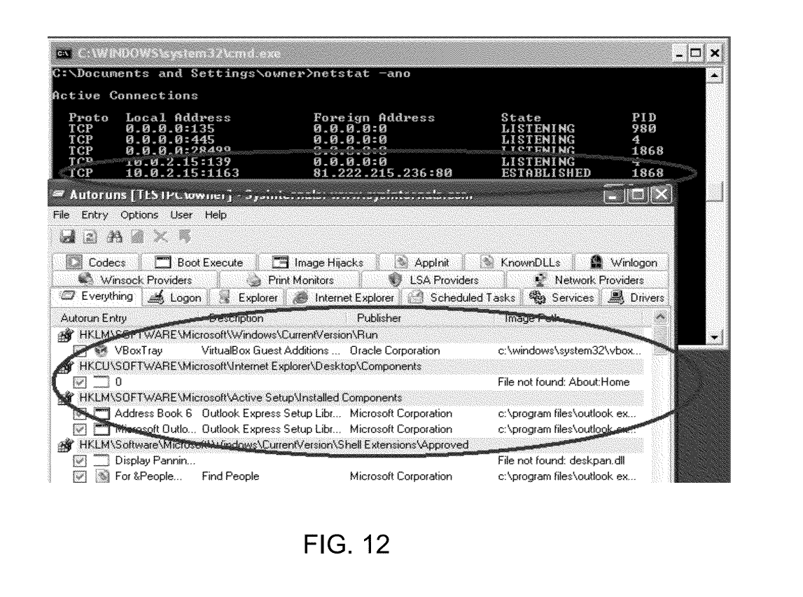

If the virus is run in unprotected mode, the virus is able to run, but is still not able to fully infect the machine. As can be seen in FIG. 12, an attempt to connect to a malicious botmaster is made, but it is not running as a system (PID 0). Additionally, no infected auto starting programs can be installed. Thus, while the virus is live and able to connect, it is not actually able to infect. Therefore, when the machine is rebooted, the virus is gone.

As will be appreciated to one of ordinary skill in the art, the aforementioned example architectures can be implemented in many ways, such as program instructions for execution by a processor, as software modules, microcode, as computer program product on computer readable media, as logic circuits, as application specific integrated circuits, as firmware, as consumer electronic device, etc. and may utilize wireless devices, wireless transmitters/receivers, and other portions of wireless networks. Furthermore, embodiment of the disclosed method and system for displaying multimedia content on multiple electronic display screens can take the form of an entirely hardware embodiment, an entirely software embodiment, or an embodiment containing both software and hardware elements.

The term “computer readable medium” is used generally to refer to media such as main memory, secondary memory, removable storage, hard disks, flash memory, disk drive memory, CD-ROM and other forms of persistent memory. It should be noted that program storage devices, as may be used to describe storage devices containing executable computer code for operating various methods of the present invention, shall not be construed to cover transitory subject matter, such as carrier waves or signals. Program storage devices and computer readable medium are terms used generally to refer to media such as main memory, secondary memory, removable storage disks, hard disk drives, and other tangible storage devices or components.

Although only a few embodiments of the invention have been described in detail, it should be appreciated that the invention may be implemented in many other forms without departing from the spirit or scope of the invention. Therefore, the present embodiments should be considered illustrative and not restrictive and the invention is not to be limited to the details given herein, but may be modified within the scope and equivalents of the appended claims.

What is claimed is:

1. A method for enabling a device to block malicious software, comprising:
creating a super-user account as a new account for an operating system running on a device; and
altering security rights of the operating system so that all accounts other than the super-user account of the operating system running on the device have only read access to key sections of the operating system.

2. The method of claim 1, wherein the operating system provides for members of an administrator's group to take ownership of operating system sections, and wherein the method further comprises:
removing the right of members of the administrator's group to take ownership of key operating system sections.

3. The method of claim 1, further comprising permitting restoration of original access rights without requiring a reboot of the device.

4. The method of claim 1, wherein the key sections of the operating system include sections that allow programs to execute automatically.

5. The method of claim 1, wherein the key sections of the operating system include sections that operate as add-ons for other programs.

6. The method of claim 1, wherein the key sections of the operating system include a boot sector of the operating system.

7. The method of claim 1, wherein the key sections of the operating system include layered service providers.

8. The method of claim 1, wherein the key sections of the operating system include system drivers folders.

9. The method of claim 1, wherein the super-user account is created on a local computer.

10. The method of claim 1, wherein the super-user account is created on a domain controller.

11. A method for enabling blocking malicious software, comprising:
receiving a command to open a file;
prompting the user as to how to run the command, wherein the prompting includes asking the user to select “high-risk” or “low-risk”; and
when the user selects “high-risk,” running the command in a guest mode, where the command is not allowed to access any part of the operating system.

12. The method of claim 11, wherein the prompting includes asking the user to select “high-risk, “medium-risk,” or “low-risk,” and wherein the method further comprises when the user selects “medium risk,” running the command in a user mode, wherein the command is not allowed to access any part of the operating system except to perform non-threatening tasks.

13. A computer system comprising:
a processor;
an operating system, wherein the operating system contains key sections and non-key sections;
a user account module, wherein the user account module is configured to:
create a super-user account as a new account for the operating system; and
alter security rights of the operating system so that all accounts other than the super-user account of the operating system running on the device have only read access to the key sections of the operating system.

14. The computer system of claim 13, wherein the operating system is a Windows operating system.

15. A program storage device readable by a machine tangibly embodying a program of instructions executable by the machine to perform a method for enabling a device to block malicious software, the method comprising:
creating a super-user account as a new account for an operating system running on a device; and
altering security rights of the operating system so that all accounts other than the super-user account of the operating system running on the device have only read access to key sections of the operating system.

16. A program storage device readable by a machine tangibly embodying a program of instructions executable by the machine to perform a method for enabling blocking malicious software, the method comprising:
receiving a command to open a file;
prompting the user as to how to run the command, wherein the prompting includes asking the user to select “high-risk” or “low-risk”; and
when the user selects “high-risk,” running the command in a guest mode, where the command is not allowed to access any part of the operating system.
